(19) United States
(12) Patent Application Publication
(10) Pub. No.: US 2013/0143726 A1
(43) Pub. Date: Jun. 6, 2013

(54) SYSTEM AND METHOD FOR FORMING RUFFLES ON A WEB

(71) Applicant: EVERYDAY HAUTE, LLC, Fernandina Beach, FL (US)

(72) Inventors: Lynda Middlemas, Amelia Island, FL (US); Amanda Morgan Middlemas, Washington, DC (US)

(73) Assignee: EVERYDAY HAUTE, LLC, FERNANDINA BEACH, FL (US)

(21) Appl. No.: 13/758,011

(22) Filed: Feb. 4, 2013

Related U.S. Application Data
(63) Continuation-in-part of application No. 12/964,445, filed on Dec. 9, 2010.

(51) Int. Cl. B31D 5/00

(52) U.S. Cl. CPC B31D 5/00
USPC 493/340

(57) ABSTRACT

Systems and methods for forming creased or uncreased ruffles along one or more outside edges of a sheet entail integral formation or attachment of a ruffle strip. Integral formation entails selectively embossing ruffled areas of a web. Perforations may be formed to impart a lace appearance. The result is an integrally formed ruffled in a paper napkin, towel or the like.

### RELATED APPLICATION

This application is a continuation-in-part and claims the benefit of priority of U.S. Nonprovisional application Ser. No. 12/964,445 filed 9 Dec. 2010, the entire contents of which are incorporated herein by this reference and made a part hereof.

### FIELD OF THE INVENTION

This invention relates generally to paper processing, and, more particularly to systems and methods for forming creased or uncreased ruffles on a web.

### BACKGROUND

In the past, many attempts have been made to enhance physical and aesthetic properties of textiles, nonwovens and paper products, e.g., napkins and hand towels. By way of example, paper napkins are typically made from one up to four plies and in a variety of qualities, sizes, folds, colors and patterns depending on intended use and prevailing fashions. The composition of raw materials varies considerably, depending upon requirements and quality.

One technique for imparting unique physical and aesthetic properties to paper products is creping. Crepe paper is typically produced on a paper machine with a single large steam heated drying cylinder (yankee) fitted with a hot air hood. The yankee cylinder is sprayed with adhesives to make the paper stick. Creping is accomplished by the Yankee's doctor blade that is scraping the dry paper of the cylinder surface. The crinkle (creping) is controlled by the strength of the adhesive, geometry of the doctor blade, speed difference between the yankee and final section of the paper machine and paper pulp characteristics.

Another technique for imparting unique physical and aesthetic properties to paper products is calendering. Calendering modifies the surface characteristics of paper with regard to its further use. Calendering can impart a specific gloss, smoothness/roughness, density, brightness and opacity.

Yet another technique for imparting unique physical and aesthetic properties is coating. Coating affects the surface properties of the paper. The effect of coating may be aimed at optical properties such as brightness, gloss or opacity, at tactile properties such as smoothness, but, most importantly, at printability and print image quality.

While available paper processing techniques are useful for producing a wide array of unique features, they do not satisfactorily enable mass production of paper products having creased or uncreased ruffles formed along one or more sections (e.g., free edges). Ruffles can provide not only a unique aesthetic appearance but also unique physical properties at the ruffled edge. A system and method are needed for forming creased or uncreased ruffles along one or more outside edges of a sheet, efficiently and cost effectively, during small scale and mass production of paper and paper-like products.

Furthermore, there exists an intense desire in the paper industry to create disposable products from papermaking fibers which can substitute for conventional cloth products used for the purpose of wiping and cleaning Their physical properties, appearance and functioning must closely duplicate the cloth based products in order to gain market acceptance. For example, their softness, bulk, extensibility, absorbency, presentation and dispensability, should match their cloth counterparts.

Softness is expected from all wiping products. Not only does it feel better to handle a soft wiping product, but it also gives a sense of greater wiping ability and absorbency. Absorbency is the ability to soak up liquids quickly. Another indication of softness and absorbency is bulk, the thickness of the sheet, which makes it “bulky” and cloth-like. It is a frequent practice to use more than one ply to make the product bulky, which has cost implications. Extensibility allows the product conform to the shape of the hand. This further increases the comfort in use.

From the aesthetic point of view, cloth napkins and towels are usually bordered. This border could be in the form of hemming, tufting, or ruffling. The closest simulation of this in a paper napkin is the embossed border pattern on typical dinner napkins A method of embossing in the middle and crushing the sheet for the borders is described in U.S. Pat. No. 1,771,983. The crushing pressure in the above methods makes the edges harsh to the feel, makes them thin and “papery” and reduces absorbency along the edges. In order to overcome the thin and harsh edges, U.S. Pat. No. 1,774,497 folds the edges over and seals them, a fairly complex and wasteful process. U.S. Pat. No. 2,020,668 describes the process of manufacturing a two or more plied handkerchief with hemmed edges. The sheets are unattached to each other except along a band which lies substantially inside the margin of the handkerchief. The unattached portion outside the bands is free to separate and independently ruffle. All of the above patents describe the use of more than one ply to make the product.

Disposable towels on the other hand are usually embossed over their entire surface for increasing bulk, extensibility and absorbency. The full coverage with the pattern usually gives them a grainy and unattractive appearance.

Conventional creped tissue paper is formed from aqueous slurries, and the principle source of strength is from inter-fiber bonds formed by the hydrate bonding process associated with papermaking Stiffness of paper is associated with the concentration of bonds, bonds per unit area of the sheet. Adding small amounts of de-bonder to the slurry will make a softer but weaker sheet. Adding more fiber to make a bulkier sheet will form an undesirably stiffer sheet. Experience dictates that two thinner sheets put together make a considerably softer sheet than a thicker sheet made in the conventional process using the same slurry. It is, therefore, a common practice to make disposable napkins and towels using more than one ply. The disadvantage of this process is that it requires running the paper machine several times to make the same length of the final product.

Various methods have been employed to make bulkier and softer sheets. U.S. Pat. No. 3,879,257 describes a recrepe process in which the creped web from the first dryer is printed in a mesh pattern with an elastomeric material on one side, and then adhered to a second drying cylinder and creped off, the bonding agent acting as the adhering agent. It is printed again on the other side of the web and recreped on a third drying cylinder. The strength of the elastomeric material and the breakdown of the bonds in the unprinted areas as a result of repeated creping create a fairly bulky, strong and absorbent sheet.

Another process to add bulk and extensibility to the web is described in U.S. Pat. No. 6,416,623. Partially dried creped web from the drying cylinder is embossed in a press nip of a heated cylinder and soft rubber belt or wire pressing against it. Either the cylinder or the belt or the wire is patterned. The web is finally dried. The process produces bulky sheet with high extensibility.

The papermaking processes do not allow for making a non-uniform web comprising discrete machine direction bands with different properties, such as, uncreped bands or bands of dissimilar crepe, or embossed bands interspersed with bands of dissimilar embossing or absence of embossing.

U.S. Pat. No. 1,506,592 discusses a process to make ordinary crepe paper or other crepe material with ruffles to enhance the decorative effect. It is an off paper machine process where the web is folded longitudinally, each fold in the form of a pleat. It is then adhered to a heated cylinder with adhesive, dried and creped. The web is creped everywhere except the outside layers of the fold which ruffle up. The process, though practical for the much stronger decorative paper, would have operational problems for much weaker sanitary paper, such as sheet breakage at the crepe blade, non-uniform crepe under the folds, and mutual bonding of the folds due to adhesive penetration through the layers of the fold. Additionally, such a post-machine process is impractical for today's mass production.

The invention is directed to overcoming one or more of the problems and solving one or more of the needs as set forth above.

### SUMMARY OF THE INVENTION

To solve one or more of the problems set forth above, in an exemplary implementation of the invention, systems and methods for forming creased or uncreased ruffles along one or more outside edges of a sheet are provided. The systems and methods entail integral formation or attachment of a ruffle strip. Ruffles may be integrally formed on a web by stretching (e.g., embossing) ruffled areas. Alternatively, ruffles may be formed as a separate strip that converges with a web in a manufacturing line and is glued or stitched to the web.

The invention enables production of single ply fibrous products that exhibit enhanced softness, bulk and absorbency. However, the invention is not limited to producing such products.

The systems and methods of the present invention enable production of products having creased or uncreased ruffles formed along one or more sections (e.g., free edges). The ruffles provide not only a unique aesthetic appearance but also unique physical properties (e.g., stretched and therefore thinned material) at the ruffled edge.

A sheet is created when a web is slit. A method of forming a ruffle along an edge of a sheet of a substrate material in accordance with principles of the invention includes a step of forming a ruffle zone between lateral edges of a web of nonwoven material traveling in a machine direction. The ruffle zone includes embossed ruffles, which are stretched portions. The ruffle zone is cut in the machine direction (i.e., the direction of travel of the web) between parallel non-ruffled regions on the web. The cutting divides the ruffle zone and forms opposed edges. At least one of the opposed edges is ruffled.

The step of cutting the ruffle zone in the machine direction between parallel non-embossed regions of a web includes tangential shear slitting between two edge-contacting circular slitter blade, including a top slitter blade and a bottom slitter blade vertically supported in a path of machine direction travel in alignment with the ruffle zone, e.g., in alignment with a midline of the ruffle zone or offset from the midline. Another implementation includes crush cutting. In this cutting technique, the material is severed when it is nipped between a sharp-edged cutter element and an anvil element.

Optionally, the ruffle zones, non-ruffled portions or the entire web may be heat set to provide enhanced stability and durability. Also optionally, the cut ruffle zone may be mechanically or pneumatically fluffed to mechanically enhance the amplitude of undulations comprising ruffles.

In another embodiment, a plurality of ruffle zones are formed between lateral edges of a web of nonwoven material traveling in a machine direction. Each ruffle zone comprises an embossed region between adjacent parallel a non-embossed region the web. Each ruffle zone may be cut (e.g., slit) in the machine direction between the corresponding adjacent parallel a non-embossed region the web. The cutting divides the ruffle zone and forms opposed edges of separate sheets of the nonwoven material. Each of the opposed edges is ruffled. This embodiment produces a plurality of sheets with ruffled edges from a single web. The optional steps and particular embossing steps described above may be applied in this embodiment.

An exemplary product of a process as described above is a unitary ruffled sheet. The unitary ruffled sheet is a thin sheet of material with a plurality of edges. At least one edge is an integrally formed ruffled edge. In a particular preferred embodiment each lateral edge is an integrally formed ruffled edge. Each ruffled edge comprises embossed sheet material, with embossments of depths and widths significant enough to impart ruffling. At least a portion of the thin sheet that abuts each ruffled edge (but excludes the ruffled edge) comprises non-ruffled sheet material. The non-ruffled sheet material is may exhibit some undulations or bunching in the transitional region adjacent to the ruffled edge.

Thus, systems and methods for forming creased or uncreased ruffles along one or more outside edges of a sheet entail integral formation or attachment of a ruffle strip are provided. Integral formation entails selectively embossing ruffled areas of a web. Perforations may be formed to impart a lace appearance. The result is an integrally formed ruffled in a paper napkin, towel or the like.

The method of forming a ruffle on a web of substrate material, the web having parallel lateral edges, including a first lateral edge and an opposite second lateral edge, includes steps of forming an intermediate ruffle zone between the lateral edges of the web of substrate material traveling in a machine direction, the intermediate ruffle zone includes an embossed region between adjacent parallel non-embossed regions on the web, the embossed region being embossed with undulations forming ruffles; and slitting the ruffle zone in the machine direction between the parallel non-embossed regions, the slitting dividing the ruffle zone and forming opposed ruffled edges. The method may further include forming a first ruffle zone along the first lateral edge, forming a second ruffle zone along the second lateral edge. Second, third and more intermediate ruffle zones with undulations forming ruffles may also be formed. Ruffle zones may also be formed along the first and second lateral edges. The step of slitting the ruffle zone in the machine direction between the parallel a non-embossed region the web may entail tangential shear slitting between two edge-contacting circular slitter blades, including a top slitter blade and a bottom slitter blade vertically supported in a path of machine direction travel in alignment with the ruffle zone; or crush cutting between a sharp-edged cutter element and an anvil element in a path of machine direction travel with the sharp-edged cutter element in alignment with the ruffle zone. Parallel non-ruffled regions and/or ruffled zones may be heat set. Ruffle zones may be fluffed, the fluffing entailing mechanically enhancing an amplitude of undulations includes ruffles, such as by pneumatically enhancing an amplitude of undulations includes ruffles.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a top perspective view of exemplary embossing cylinders according to principles of the invention; and

FIG. 2 is a side view of exemplary embossing cylinders according to principles of the invention; and

FIG. 3 is a top perspective view of exemplary embossing cylinders with punches according to principles of the invention; and

FIG. 4 is a top perspective view of exemplary extended width embossing cylinders with punches according to principles of the invention; and

FIG. 5 is a top perspective view of an exemplary embossing cylinder with a resilient cylinder according to principles of the invention; and

FIG. 6 is a top perspective view of an exemplary embossing plate according to principles of the invention; and

FIG. 7 is a top plan view of an exemplary pattern of perforation by punches according to principles of the invention; and

FIG. 8 is a top plan view of another exemplary pattern of perforation by punches according to principles of the invention; and

FIG. 9 is a perspective view of an exemplary roller with hollow punches and an air conduit in fluid communication with the hollow punches to pneumatically expel debris according to principles of the invention; and

FIG. 10 is a high level flowchart of a ruffle-forming process according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures.

### DETAILED DESCRIPTION

The system and method of the present invention enables mass production of paper products having creased or uncreased ruffles formed along one or more sections (e.g., free edges). The ruffles provide not only a unique aesthetic appearance but also unique physical properties at the ruffled edge.

Ruffles according to principles of the invention may be creased or uncreased. As used herein, an uncreased ruffle is an area of smooth undulation, without creases, that defines an edge of a sheet. The ruffle may be tightly gathered where it abuts the sheet and increasingly wavelike towards the free end thereof. A pleat is a creased ruffle. The configuration (e.g., width) of the ruffle is not a limiting factor.

A ruffle according to principles of the invention may be formed on any substrate that is processed as a web or sheet and exhibits adequate structural properties. Paper and paper-like materials are examples of suitable substrates. Thus, a ruffle may be formed on a broad range of paper products, including, but not limited to, folded hand towels, folded napkins, rolled bath tissue and streamers, each of which is typically formed from a continuous web supplied from a paper roll. Additionally, ruffles formed in accordance with the principles of the invention may be attached to other substrates, including, but not limited to gift bags.

The web may be comprised of any substrate capable of supporting a ruffle. Various woven and/or non-woven materials and textiles may be used, including, but not limited to fabrics. To facilitate forming a ruffle by embossing, a substrate that exhibits substantially inelastic stretch is preferred. By way of example and not limitation, air laid nonwoven web, spun lace nonwoven webs, or DRC (Double Re-Crepe) cellulose webs are examples of nonwovens that may be used. As between the three, air laid and spun lace are particularly preferred for aesthetic reasons.

Air laid nonwoven refers to a manufacturing technology that produces a web from short fibers, most often softwood pulp. The process is also referred to as short fiber air laid technology. Unlike conventional paper making where wood pulp is bonded principally by a chemical reaction between the pulp's natural cellulose and water, air laid nonwoven technology generally uses latex emulsions, thermoplastic fibers or some combination of both to bond the web's fibers and increase the strength and integrity of the sheet. The process yields a paper-like fabric that is thicker, softer and more absorbent than paper. It also has greater tear resistance and tensile strength, particularly when wet.

Spun lacing uses high-speed jets of water to strike a web so that the fibers knot about one another. As a result, nonwoven fabrics made by this method exhibit softness and drapability.

DRC is a non-woven fabric made from strong wood fibers combined with a binder (e.g., a synthetic latex) and then double creped to give the fabric inelastic stretch as well as softness and wipe-dry properties. DRC exhibits a very cloth-like feel and a high machine direction stretch. Sellars Absorbent Materials, Inc. of Milwaukee, Wis. and Kimberly-Clark Corporation of Dallas, Tex. manufacture DRC.

In accordance with principles of the invention, a few techniques may be used to form a ruffle along an edge. One technique entails integrally forming a ruffle on a web, e.g., along one or more edges of the web, and or along parallel bands of the web using embossing rollers and/or plates. Another technique entails forming a perforated ruffled edge using punches to form a pattern of perforations in a ruffled region. Additionally, the perforations may be formed without ruffles for a lace region.

All of these methods are integral techniques. An integral technique is a single-component technique. A web of material is processed in such a way that one or more of its edges become ruffled. The part that is ruffled is an integral part of the web, not attached as a separate piece. Ruffles may be integrally formed on more than one edge, and at areas other than an edge.

A ruffle may be integrally formed on a sheet or strip of material, which is subsequently attached to another sheet. While such a technique involves attaching the strip, such a ruffle is intended to come within the scope of the invention.

In the perforating technique, a portion such as an edge is perforated before or during ruffling. The perforations may be in a format of a design to give the appearance of a lace edge. The perforations my bear any shape, including, but not limited to pinhole, circular, rectangular, triangular, irregular and others.

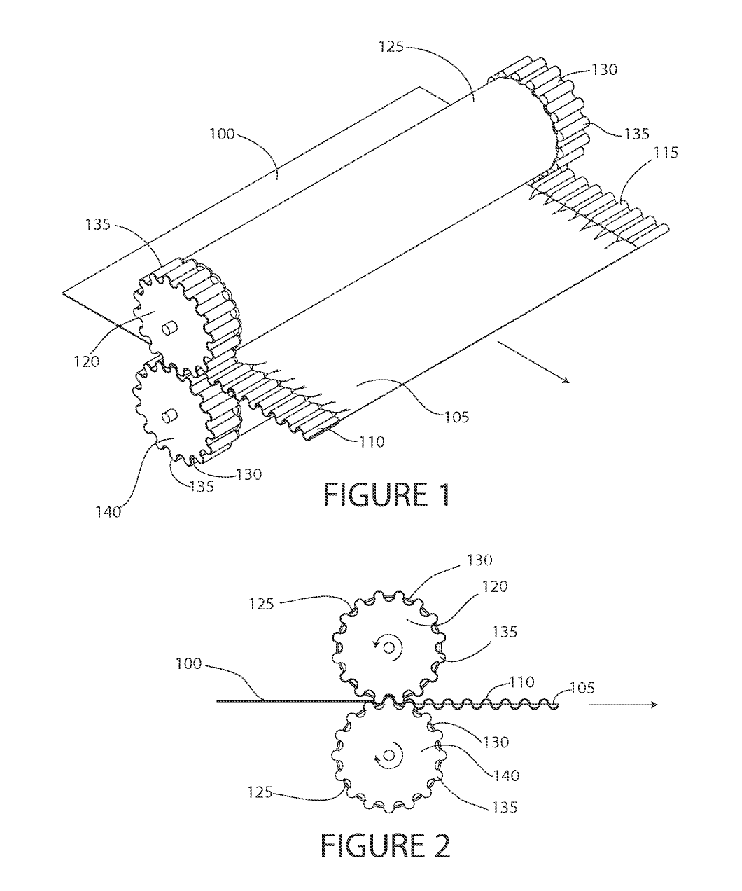

With reference to FIGS. 1 and 2, top perspective and front views of exemplary edge embossing rollers according to principles of the invention are conceptually illustrated. Embossing gives the paper a three-dimensional undulating edge pattern. Union embossing rollers 120, 140 comprise two rigid rolls. One roller 140 rotates clockwise while the other roller 120 rotates counterclockwise to continuously draw the web 100 through the space therebetween. One or both rollers may or may not be heated to facilitate stretching and/or make the stretch more permanent. The rollers 120, 140 have embossing areas comprising smooth wavelike undulations featuring successive peaks 135 and valleys 130 that mesh. Having a somewhat conical shape with a tapered amplitude in the successive peaks 135 and valleys 130 that mesh, may be advantageous. In such an implementation the elevations of the peaks 135 and valleys 130 would gradually approach each other near the unruffled areas of the web, and be at their maximum difference in elevation at the point that will coincide with the eventual free edges of the ruffles. The configuration of the embossing areas stretches the contacted areas 110, 115 of the drawn web 105 without causing structural failure. The remaining portion(s) 125 of the rollers 120, 140 do not cause similar stretching. In a practical application, the part of FIG. 1 that is numbered 125 could be a narrow shaft. Such portions may be smooth or textured to impart certain properties to the unstretched section(s) 105of the web 100. The distance between the rollers 120, 140 is adjusted in such a way that it is identical or nearly identical to the thickness of the web 100 to be embossed or greater than the thickness of the web 100. The result of union embossing is stretching at the edge of the web 100. Each stretched area 110, 115 exhibits a smooth undulating pattern that converges on the adjacent, unstretched, generally planar portion 105. The smooth undulating pattern 110, 115 forms an integral ruffle in the web 100.

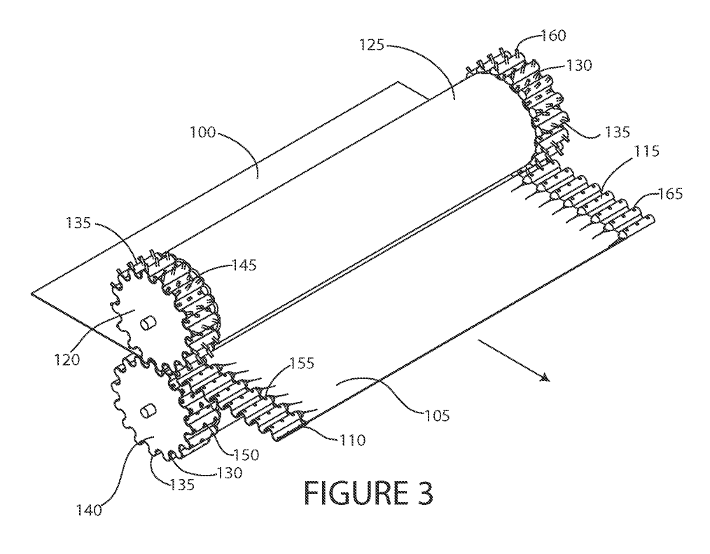

In FIG. 3, an embodiment with punches 145, 160 is conceptually illustrated. The punches 145, 160 perforate and/or emboss shapes 155, 165 into the web 100. The shapes, dimensions and arrangement of the embossments and/or perforations may vary. A linear or nonlinear repeating pattern of embossing and/or perforations may be produced to generate a lace-like appearance.

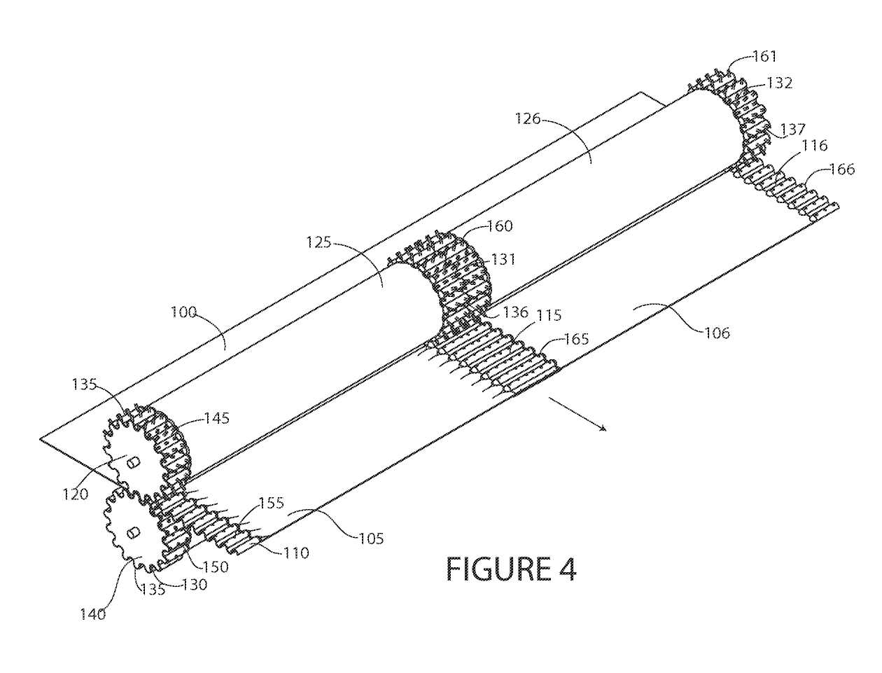

While two ruffles are shown on opposite edges of the web 100 in FIGS. 1 and 3, fewer or more ruffles may be formed. By way of example, a ruffle may be formed along only one edge. Alternatively, one or more intermediate ruffles may be formed between the edges, as shown in FIG. 4. There, a wide, intermediate, generally symmetric ruffle with opposed transitional portions leading to the unruffled web. In subsequent processing, a blade may slice the web between each intermediate ruffle. Each portion of the sliced ruffle will then form an edge of a roll or sheet having a narrower width than the original roll. Union embossing rollers 120, 140 comprise two rigid rolls. One roller 140 rotates clockwise while the other roller 120 rotates counterclockwise to continuously draw the web 100 through the space therebetween. One or both rollers may or may not be heated to facilitate stretching and/or make the stretch more permanent. The rollers 120, 140 have embossing areas comprising smooth wavelike undulations featuring successive peaks 135, 136, 137 and valleys 130, 131, 132 that mesh. Having a somewhat conical shape with a tapered amplitude in the successive peaks 135, 136, 137 and valleys 130 that mesh, may be advantageous. In such an implementation the elevations of the peaks 135, 136, 137 and valleys 130, 131, 132 would gradually approach each other near the unruffled areas of the web, and be at their maximum difference in elevation at the point that will coincide with the eventual free edges of the ruffles. The configuration of the embossing areas stretches the contacted areas 110, 115, 116 of the drawn web 105, 106 without causing structural failure. The remaining portion(s) 125, 126 of the rollers 120, 140 do not cause similar stretching. In a practical application, the part of FIG. 4 that is numbered 125, 126 could be a narrow shaft. Such portions may be smooth or textured to impart certain properties to the unstretched section(s) 105, 106 of the web 100. The distance between the rollers 120, 140 is adjusted in such a way that it is identical or nearly identical to the thickness of the web 100 to be embossed or greater than the thickness of the web 100. The result of union embossing is stretching at each edge of the web 100 and in one or more portions between the edges. Each stretched area 110, 115, 116 exhibits a smooth undulating pattern that converges on the adjacent, unstretched, generally planar portion 105. The smooth undulating pattern 110, 115, 116 forms an integral ruffle in the web 100. The intermediate ruffled zone 115 is subsequently cut or sliced to form separate ruffled edges.

In this embodiment, punches 145, 160, 161 and female holes 150 are shown. The punches 145, 160, 161 and mating holes 150 enable simultaneous ruffling and perforating and/or embossing 155, 165, 166, as described above, for a lace effect.

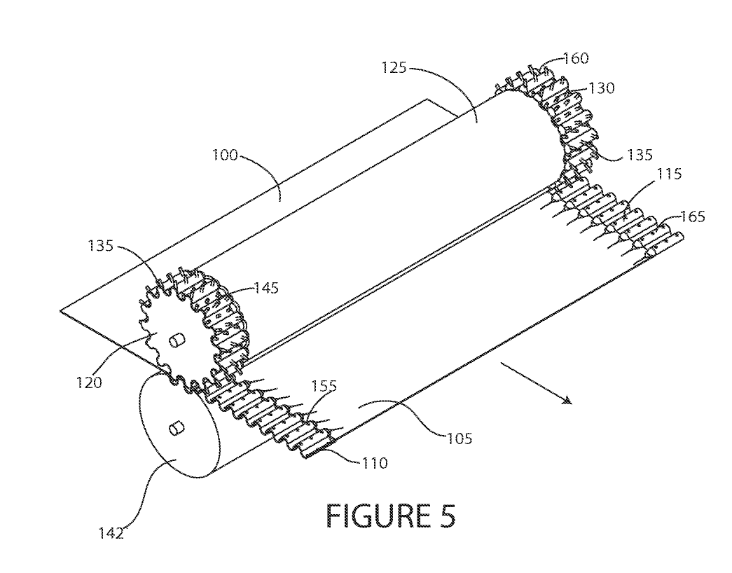

Embossing by means other than union calenders or rollers may be applied to form the desired undulating pattern of stretching. For example, matrix embossing may be applied. As in FIG. 5, equipment for matrix embossing comprises a heated roll and a soft covered roll whose diameter is typically different than that of the top roll (e.g., twenty five to two hundred percent greater). The soft covered roll may be a roller with a smooth elastic and resilient surface. The top roll includes one or more embossing areas, as described above. By pressing both rolls together and running them at low speed, the pattern of the top roll is imprinted on the bottom roll. As a result, a paper web passed through the nip will have an embossed laid pattern on the embossed sections of the web. This embodiment may include or omit punches 145, 160, to further emboss or perforate 155, 165 the ruffle zones 110, 115. If punches are included, the soft covered roll 142 may resist perforation or include mating female holes into which the punches periodically matingly extend during roll to roll processing.

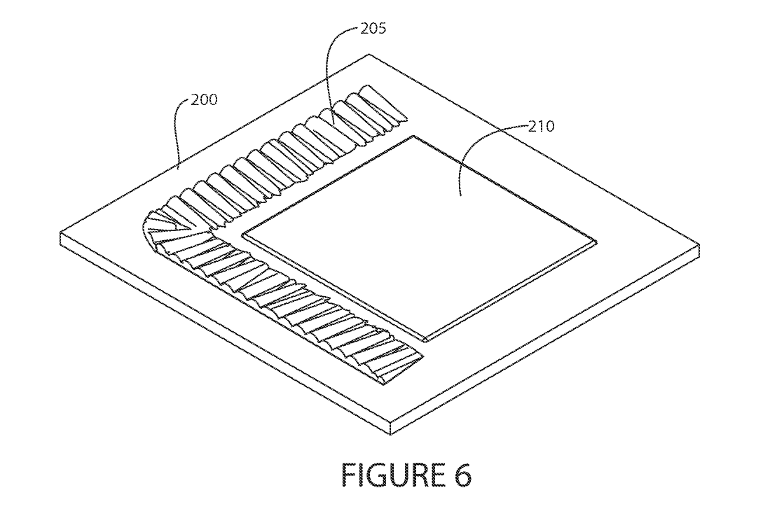

Referring now to FIG. 6, an embossing plate 200 is conceptually shown. The plate includes a raised ruffle zone 205 and optional raised center 210. A mating plate having a corresponding recessed ruffled zone and depressed center mates with the emboding plate. When pressed together, the plates form a ruffle in an intermediate sheet of material. A large plate may have several ruffle zones and centers, enabling formation of ruffles at various locations on a large sheet. The sheet may then be folded and/or cut to form one or more ruffled napkins Optionally, each ruffle zone or the entire sheet may be heat set to provide enhanced stability and durability. Also optionally, the ruffle zone may be mechanically or pneumatically fluffed to mechanically enhance the amplitude of undulations comprising ruffles.

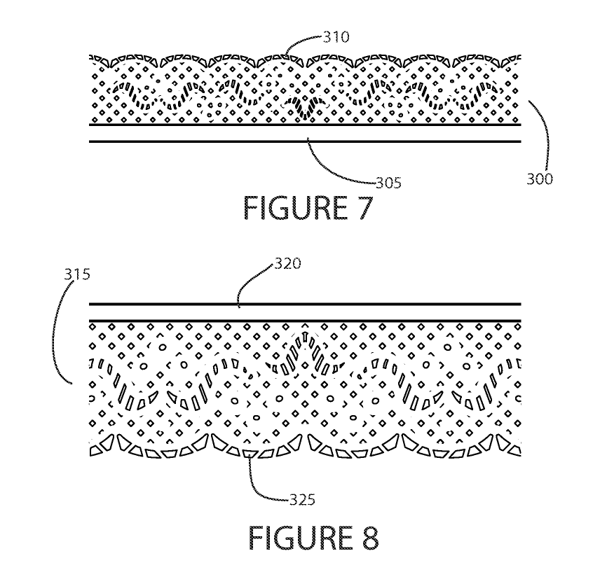

Referring now to FIGS. 7 and 8, nonlimiting examples of perforation patterns are conceptually illustrated. In FIG. 7, the pattern includes a pair of embossed bands 305 adjacent to a wavy pattern of perforations 300, which includes border perforations 310 that would abut unperforated material. Likewise, in FIG. 8, the pattern includes a pair of embossed bands 320 adjacent to a wavy pattern of perforations 315, which includes border perforations 325 that would abut unperforated material. The perforations may be formed by pins or punches to provide a lace-like appearance. Punches may also be used to form embossments to provide a textured design in the lace pattern.

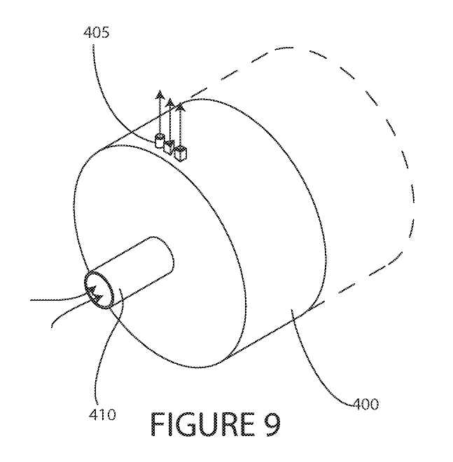

Referring now to FIG. 9, a perspective view of an exemplary roller 400 with hollow punches 405 and an air conduit 410 in fluid communication with the hollow punches 405 to pneumatically expel debris (i.e., chads) according to principles of the invention is conceptually shown. During perforation, debris may plug the hollow punch. Eventually, accumulated debris may fill the hollow of the punch. At that point, the punch loses effectiveness in forming perforations. To avoid plugging, pressurized air or other gas (e.g., nitrogen) may be forced into the inlet 410, which is in fluid communication with the hollow portions of the perforations 405. The pressurized gas expels debris from the punch and prevents debris from entering the punch. During perforating, when a punch is mated with the material and opposite roller, the airflow through unimpeded punches increases. Thus, as the roller progresses through a cycle, the airflow through a punch varies from a maximum to a minimum.

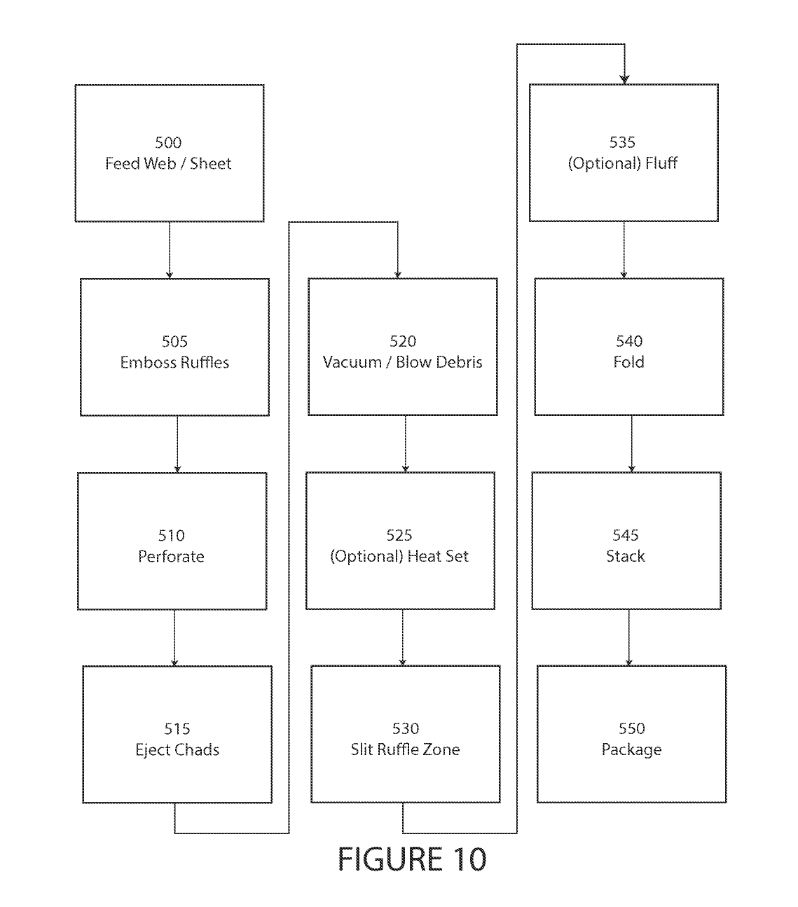

Referring now to FIG. 10, a high level flow chart conceptually illustrates steps of an exemplary ruffling methodology according to principles of the invention. The first step 500 of the exemplary methodology entails feeding a web or sheet. Then ruffle zones are formed by embossing, as in step 505. Processes of forming ruffle zone are described above. During, before or after embossing, perforations may optionally be formed as in step 510. As described above, the optional perforations provide a lacelike effect. If perforations are formed, chads are ejected from punches as ins step 515. Pressurized gas or a vacuum may be used to eject the chads. To minimize accumulation of ejected debris, the web and equipment may be vacuumed or blown clear, as in step 520. This may be accomplished by positioning one or more nozzles near the affected areas. Optionally, the embossed sheet or web may be heat set, as in step 525. Heat setting 305 is optional and may occur at any of various stages of the process, including before or after slitting. Heat setting entails thermally processing the material in either a steam atmosphere or a dry heat environment. The effect of the heat setting is enhanced fabric dimensional stability and, often, higher volume and wrinkle resistance, and enhanced ruffle durability and stability. Heat setting may be accomplished off-line by placing the material in an autoclave. Alternatively, in-line steaming and drying steps may be performed to accomplish heat setting. Heat setting may also be accomplished by exposure to heated rolls, heated air streams and the like.

Intermediate ruffle zones between edges of a sheet or web may be slit to form separate ruffed edges, as in step 530. While various slitting techniques are available, e. g. water jet slitting and laser slitting, tangential shear slitting as described above is preferred.

Another step of the exemplary process is fluffing, as in step 535. Fluffing 535 entails mechanically and/or pneumatically urging the ruffled sections to enhance the amplitude of the formed ruffles. Fluffing produces a more full-bodied ruffle. One or more air streams and/or compressed air jets may impinge upon the ruffled area. In one exemplary embodiment, spaced apart oppositely directed pulsed jets of compressed air may be directed at a ruffled area to enhance the magnitude of the undulations. Alternatively, a web may be advanced on brushes and/or soft rolls to enhance the magnitude of the undulations. As another alternative, the material may be vibrated, such as by traveling over a vibrating roller, to accentuate the undulations. As yet another alternative, the free edge may be mechanically stretched by running a free edge over a longer path than the remaining portions. Stretching may be used alone or in combination with one or more of the aforementioned fluffing techniques to provide a full-bodied ruffle.

Subsequently, individual sheets may be cut and folded, as in step 545. Then the folded sheets are stacked and packaged as in steps 550 and 555.

An exemplary product of a process as described above is a unitary ruffled sheet. The unitary ruffled sheet is a thin sheet of material with a plurality of edges. At least one edge is an integrally formed ruffled edge. In a particular preferred embodiment each lateral edge is an integrally formed ruffled edge. Each ruffled edge comprises stretched and thinned sheet material with wavelike undulations that may be creased or uncreased. At least a portion of the thin sheet that abuts each ruffled edge (but excludes the ruffled edge) comprises non-ruffled sheet material.

A hand towel, having a ruffle applied to one edge (i.e., a machine direction edge), is easier to produce than a napkin with a ruffle around multiple edges. Nevertheless, skilled artisans will appreciate that the invention enables forming ruffles on more than one edge, including perpendicular edges. For example, a stream of towels or napkins may be fed into an embossing station to add a ruffle to edges using an embossing plate as described above with reference to FIG. 6. The plate allows embossing ruffles into perpendicular edges. Other stretching and compaction operations may be applied to the paper product to facilitate forming additional ruffles.

The “ruffle factor” quantifies fullness of the ruffles. It is calculated as a ratio of lengths. For a strip that is ruffled on one edge, the ruffle factor would be the unruffled length of the long edge divided by the linear length of the ruffled edge. Greater values for the ruffle factor result in more full-bodied ruffles. Ruffle factors between 2 and 3 have been found satisfactory, and are achievable using the methods described above.

The invention offers many advantages beyond forming ruffles. The principal method of selectively compacting regions of a web to form ruffles is a pure mechanical process and does not require any adhesive fluid or drying, and bulks the sheet with little loss in strength. Although the primary purpose of the process is to create ruffles, other useful properties such as bulk, stretch, absorption, appearance, softness, drape ability, etc., are all improved, and all that with no or minimal compromising of strength. Again, sometime strength itself is improved.

Moreover, the invention facilitates dispensing. Individual items in stacks often have a tendency to block, i.e., they stick to each other to hinder dispensing one at a time. Often the item below has to be touched to cause separation. The situation is worse in the case of towels which have to picked up with wet fingers. Ruffles according to the invention are free formed and do not mesh or nest. Consequently, ruffled products formed in accordance with the invention can be easily picked up by the ruffled edge without touching the one below, thus ensuring sanitary dispensing.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of forming a ruffle on a web of substrate material, said web having parallel lateral edges, including a first lateral edge and an opposite second lateral edge, said method comprising steps of
forming an intermediate ruffle zone between the lateral edges of the web of substrate material traveling in a machine direction, said intermediate ruffle zone comprising an embossed region between adjacent parallel non-embossed regions on the web, said embossed region being embossed with undulations forming ruffles; and
slitting the ruffle zone in the machine direction between the parallel non-embossed regions, said slitting dividing the ruffle zone and forming opposed ruffled edges.

2. The method of according to claim 1, further comprising forming a first ruffle zone along the first lateral edge.

3. The method of according to claim 1, further comprising forming a second ruffle zone along the second lateral edge.

4. The method of according to claim 2, further comprising forming a second ruffle zone along the second lateral edge.

5. The method of according to claim 1, further comprising forming a second intermediate ruffle zone between the first lateral edge of the web of substrate material and the intermediate ruffle zone traveling in a machine direction, said second intermediate ruffle zone comprising an embossed region between adjacent parallel non-embossed regions on the web, said embossed region being embossed with undulations forming ruffles.

6. The method of according to claim 1, further comprising forming a third intermediate ruffle zone between the second lateral edge of the web of substrate material and the intermediate ruffle zone traveling in a machine direction, said third intermediate ruffle zone comprising an embossed region between adjacent parallel non-embossed regions on the web, said embossed region being embossed with undulations forming ruffles.

7. The method of according to claim 5, further comprising forming a third intermediate ruffle zone between the second lateral edge of the web of substrate material and the intermediate ruffle zone traveling in a machine direction, said third intermediate ruffle zone comprising an embossed region between adjacent parallel non-embossed regions on the web, said embossed region being embossed with undulations forming ruffles.

8. The method of according to claim 7, further comprising forming a first ruffle zone along the first lateral edge.

9. The method of according to claim 7, further comprising forming a second ruffle zone along the second lateral edge.

10. The method of according to claim 8, further comprising forming a second ruffle zone along the second lateral edge.

11. A method according to claim 1, wherein said step of slitting the ruffle zone in the machine direction between the parallel a non-embossed region the web comprises tangential shear slitting between two edge-contacting circular slitter blades, including a top slitter blade and a bottom slitter blade vertically supported in a path of machine direction travel in alignment with the ruffle zone.

12. A method according to claim 1, wherein said step of slitting the ruffle zone in the machine direction between the parallel a non-embossed region the web comprises crush cutting between a sharp-edged cutter element and an anvil element in a path of machine direction travel with the sharp-edged cutter element in alignment with the ruffle zone.

13. A method according to claim 1, wherein said step of slitting the ruffle zone in the machine direction between the parallel a non-embossed region the web comprises tangential shear slitting between two edge-contacting circular slitter blades, including a first slitter blade and an opposite second slitter blade supported in a path of machine direction travel in alignment with a midline of the ruffle zone

14. A method according to claim 1, further comprising a step of heat setting the parallel non-ruffled regions.

15. A method according to claim 1, further comprising a step of fluffing the cut ruffle zone, said fluffing entailing mechanically enhancing an amplitude of undulations comprising ruffles.

16. A method according to claim 1, further comprising a step of fluffing the cut ruffle zone, said fluffing entailing pneumatically enhancing an amplitude of undulations comprising ruffles.

17. A method according to claim 1,
wherein said step of forming a ruffle zone between lateral edges of a web of substrate material traveling in a machine direction comprises
forming a plurality of ruffle zones between lateral edges of a web of substrate material traveling in a machine direction, each ruffle zone comprising an embossed region between adjacent parallel a non-embossed region the web; and
wherein said step of slitting the ruffle zone in the machine direction between the parallel a non-embossed region the web comprises
slitting each ruffle zone in the machine direction between the corresponding adjacent parallel a non-embossed region the web, said slitting dividing the ruffle zone and forming opposed edges of separate sheets of the substrate material, wherein each of the opposed edges is ruffled.

18. A method according to claim 17, further comprising forming each parallel non-ruffled region on the web by selectively embossing areas of the web to constitute each ruffle zone, the area between each parallel non-ruffled region comprising non-embossed region, not being embossed, and exhibiting diminishing transitional stretching from embossed stretching of the ruffle zones.

19. A method according to claim 17, further comprising forming each ruffle zone on the web by selectively mechanically forming wave-like undulations on areas of the web corresponding to the ruffle zone, the area between the parallel ruffle zones comprising parallel non-ruffled regions, not having the mechanically formed wave-like undulations.

20. A method according to claim 1, further comprising perforating each ruffle zone, said perforations providing a lace-like appearance and increasing stretchability of the ruffle zone.
